(19) United States
(12) Patent Application Publication
(10) Pub. No.: US 2013/0054411 A1
(43) Pub. Date: Feb. 28, 2013

(54) INTERACTIVE PRODUCT LOCATOR

(71) Applicant: Howard Unger, Henderson, NV (US)

(72) Inventor: Howard Unger, Henderson, NV (US)

(21) Appl. No.: 13/215,064

(22) Filed: Aug. 22, 2011

(51) Int. Cl. G06Q 30/00

(52) U.S. Cl. 705/26.9

(57) ABSTRACT

An interactive product locator presents product and other information via a module to permit a purchaser to identify and select a desired product. Once selected, one or more additional modules of the interactive product locator may identify the product to the user, such as by activating a perceivable output that draws the user's attention to the product. In this manner, the interactive product locator allows products to be easily located and helps ensure a purchasers attention is focused on a particular product. The modules may be activated individually, such as to identify individual products, or may be activated in sequence, such as to identify individual to products as well as associated products, complimentary products, or accessories.

### BACKGROUND OF THE INVENTION

1. Field of the Invention

The invention relates to retail or other product displays and in particular to an interactive product locator having individual modules for disseminating product information, locating products, or both.

2. Related Art

Product displays are generally used to hold items for purchase by consumers. For example, store shelves, racks, and fixtures are traditionally used to hold products such that they may be purchased by consumers. A large selection of similar or dissimilar products may sometimes be arranged in a product display.

These traditional product displays provide different ways to arrange products. For example, shelves are used to hold products in horizontal or vertical rows typically with same product items placed behind one another or next to one another. Racks may be used to arrange products in horizontal or vertical rows as well. Other retail fixtures are traditional configured to provide horizontal or vertical arrangements as well. Typically, product labels and packaging are made readily visible when the products are arranged on traditional product displays.

From the discussion that follows, it will become apparent that the present invention addresses the deficiencies associated with the prior art while providing numerous additional advantages and benefits not contemplated or possible with prior art constructions.

### SUMMARY OF THE INVENTION

An interactive product locator is disclosed herein. In general, the interactive product locator identifies or locates particular products for purchasers. In this way, purchasers can easily pickup their products even when such products are positioned among numerous similar products. The interactive product locator utilizes interactivity (by responding to purchaser input via one or more output devices) to present product information and allow products to be selected for identification. In addition, the interactive product locator may execute presentation sequences to draw a purchasers attention to a number of different products. In this manner, the interactive to product locator can generate sales of related goods, such as product accessories, companion products, and the like. Since the identification feature helps keep a purchasers attention on a selected product, the interactive product locator also prevents distraction to foster sales of particular products versus competing or similar products.

The interactive product locator may have a variety of configurations. For example, in one embodiment an interactive product locator may comprise a first module and a plurality of second modules. The first module may comprise one or more input devices configured to receive a product selection identifying one or more selected products from a plurality of products, and one or more communication devices configured to transmit one or more activation commands.

The plurality of second modules may be associated with one or more or the plurality of products. The one or more second modules may comprise one or more communication devices configured to receive the one or more activation commands, and one or more presentation devices configured to activate upon receipt of the one or more activation commands. The one or more presentation devices may be one or more speakers, one or more lights, and one or more display screens to draw a users attention to a product for example.

The first module may be configured to send the one or more activation commands upon receipt of the product selection, and at least one of the second modules associated with the one or more selected products may be activated as a result during operation of the interactive product locator. A storage device configured to store one or more product identifiers in association with one or more second module identifiers may be used retrievably store the association between the plurality of second modules and one or more of the plurality of products. The first module may also include a display screen configured to display product information for the plurality of products. This allows a user to browse and select products at the first module. It is noted that the first module may have one or more power outputs electrically coupled to the plurality of second modules to provide power to the plurality of second modules.

Typically, the interactive product locator will be used in a retail or other sales environment. Thus, it is noted that the plurality of second modules may comprise one or more supports configured to hold one or more of the products. The plurality of second modules may also comprise one or more mounts configured to secure the plurality of second modules to a retail fixture.

In another exemplary embodiment, an interactive product locator for a retail fixture may comprise one or more first modules at the retail fixture configured to receive an input from a user that identifies one or more first products. The one or more first modules may have a display screen for displaying the one or more first products. It is noted that the retail fixture may be various structures for supporting, arranging, or holding products, such as a peg board or a shelving unit.

A plurality of second modules may also be at the retail fixture. The plurality of second modules may be configured to generate an output perceivable by the user to identify a product to a user. The plurality of second modules may be associated with the one or more first products and one or more second products, with the first products being different from the second products. One or more of the plurality of second modules may have a display screen for generating the output perceivable by to the user to identify the product to the user.

One or more communication devices may be configured to communicate one or more activation commands between the one or more first modules and the plurality of second modules. The plurality of second modules associated with the one or more first products may be configured to generate an output upon receiving the one or more activation commands while the plurality of second modules associated with the one or more second products do not generate the output.

The one or more communication devices may also be configured to communicate one or more stop commands. The plurality of second modules associated with the one or more first products may stop generating the output upon receiving the one or more activation commands.

Similar to above, the plurality of second modules may each comprise one or more support arms for holding the one or more first products and the one or more second products. In addition, the plurality of second modules associated with the one or more first products may generate the output according to a predefined sequence. This may be used to draw a users attention to not just one, but a set of different products for example.

Various methods of locating products are also disclosed herein. In one embodiment, a method of locating products with an interactive product locator comprises receiving at a first module a product selection identifying one or more selected products, retrieving from a storage device one or more second module identifiers associated with the one or more selected products, and transmitting one or more activation commands to one or more second modules identified by the one or to more second module identifiers.

A presentation device at the one or more second modules identified by the one or more second module identifiers may be activated to identify the one or more selected products to a user. Activation may occur in various ways. For example, the presentation device of each of the one or more second modules may be activated according to a predefined sequence. The presentation device may be deactivated after a predetermined period of time or upon receipt of an input at the first module (indicating that the presentation device should be deactivated).

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating an exemplary first module;

FIG. 2 is a block diagram illustrating an exemplary second module;

FIG. 3A is a perspective view of an exemplary first module;

FIG. 3B is a rear view of an exemplary first module;

FIG. 3C is a perspective view of an exemplary first module;

FIG. 4A is a perspective view of an exemplary second module;

FIG. 4B is a side view of an exemplary second module;

FIG. 5 is a perspective view of an exemplary interactive product locator at a retail fixture;

FIG. 6 is a flow diagram illustrating operation of an exemplary interactive product locator;

FIG. 7A is a block diagram of an exemplary interactive product locator in a first state;

FIG. 7B is a block diagram of an exemplary interactive product locator in a second state; and

FIG. 7C is a block diagram of an exemplary interactive product locator in a third state.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the interactive product locator enhances the presentation of one or more products in retail or other purchase settings. The interactive product locator provides the benefit of allowing purchasers to easily and conveniently find particular to products when they are looking for particular products, such as a particular make, model, or brand of a product. When purchasers are unsure of which product they need or want, the interactive product locator may function to identify one or more products meeting the needs and/or specifications of the purchaser.

As will be described further below, the interactive product locator may also be interactive, as its name implies. This is advantageous in drawing a purchaser's attention to a particular product and thus is beneficial to sales of that product. The benefit is especially desirable where products are grouped or displayed next to other similar products. This is because the interactive product locator focuses a purchaser's attention on a particular product in a “sea” of other products, helping to make sales of the particular product. In addition, the interactivity provides product information and may be implemented in a modular fashion as will also be described further below.

In one or more embodiments the interactive product locator may comprise one or more units or modules. One or more modules may be associated with one or more products. For example, one or more modules may be associated with a particular product, or a particular type or category of product. In operation, the modules may help a purchaser find a product or product type in various ways, as will be detailed herein. For example, in one or more embodiments, one or more of the modules may be activated to draw a purchasers attention to a product or products. One benefit of the interactive product locator is that the activation of a module may be triggered by various events at the module itself or at a remote module. In addition, one or more of the modules may display product information, advertising, promotions and other information. Such display may be interactive, as will also be described herein.

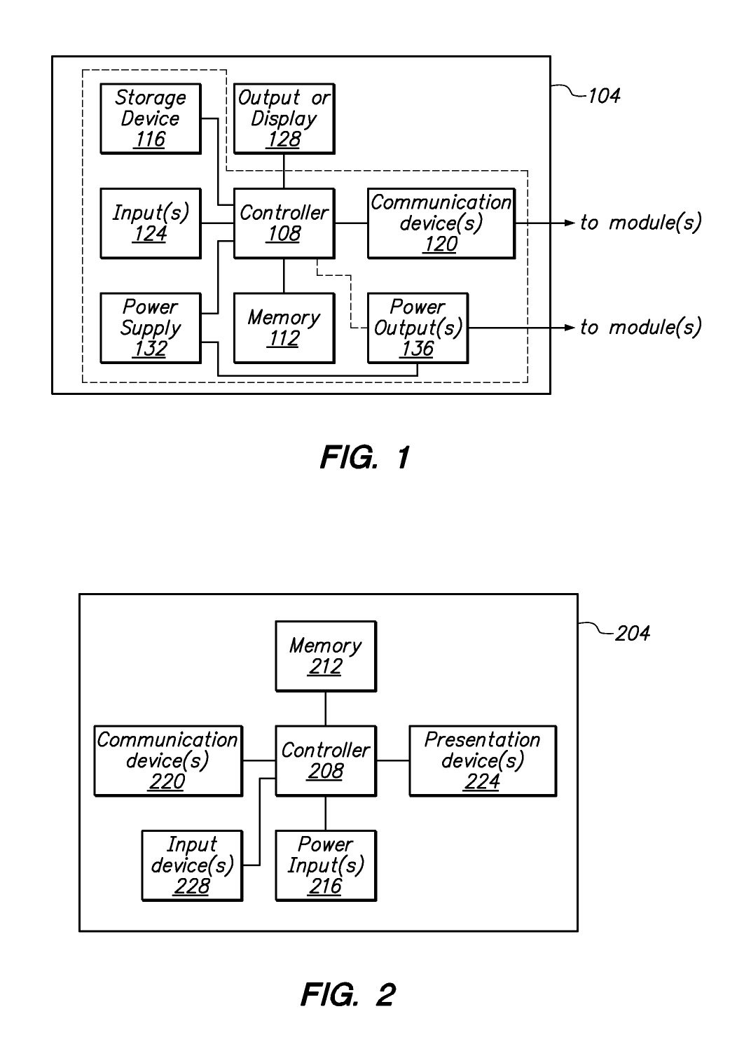

A first module type of the interactive product locator will now be described to with regard to FIG. 1. FIG. 1 is a block diagram illustrating exemplary components and configuration for a first module 104 of the interactive product locator. As can be seen, the first module 104 may comprise one or more processors or controllers 108, memory devices 112, and storage devices 116. In general, a controller 108 may receive input, process such input, and provide output to provide the functionality of the first module 104. The controller 108 may operate in cooperation with other components of the first module 104 to offer such functionality, as will be described.

In one or more embodiments, the controller 108 may execute one or more instructions to provide this functionality. The instructions may be hardwired into the processor. Alternatively or in addition, one or more instructions may be retrievably stored one a memory device 112, storage device 116, or both. For example, the memory device 112, storage device, or both may store machine readable code for execution by the controller 108.

A memory device 112 may be integrated into the controller 108 or may be a separate component. In general, a memory device 112 may provide temporary storage for machine readable code and information (e.g., product information, product locations, sounds, graphics, images, animations, videos, etc. . . . ) used by the interactive product locator. For example, a memory device 112 may be RAM, ROM, or the like.

A storage device 116 may be provided as well. In general, the storage device 116 would be used to more permanently store machine readable code and/or the interactive product locator's information. Some exemplary storage devices 116 include hard drives (and other magnetic drives), flash drives, optical drives, etc. . . . It is contemplated that any storage medium now known or later developed may be used. In one or more embodiments, a storage device 116 may store data such that it is preserved despite a loss of power.

It is noted that since a memory device 112 and a storage device 116 can both retrievably store data, they may be used in combination or instead of one another in some embodiments. The choice to include a memory device 112, storage device 116, or both may depend on the benefits provided by utilizing one form of storage over another. For example, a magnetic storage device 116 may be provided where a large amount of data needs to be stored in an inexpensive manner.

The first module 104 may also comprise one or more communications devices 120 that may be used to provide one way or two way communications to/from the first module. A communication device 120 may be configured to communicate wirelessly or via one or more cables or wires of various types. The communication device 120 may also be compatible with a variety of standard or proprietary communications protocols. Typically, a communication device 120 will be configured at least to communicate with other modules of the interactive product locator. In one or more embodiments, communications may be compressed and/or encrypted to respectively improve efficiency and security.

The first module 104 will typically also comprise one or more input devices 124 and one or more output devices 128. This allows for interactivity between a purchaser (or other user) and at least the first module 104. For example, an input device 124 may be a button, touch screen sensor, microphone, camera, motion detector, proximity detector, or the like. In general, these input devices 124 allow the to first module 104 to receive input from a purchaser. For example, the purchaser may press a button or touch screen to interact with the first module 104. In addition, the first module 104 may receive input from the purchaser via a microphone, camera, motion detector, or proximity detector. Depending on the type of input received, the first module 104 may respond differently to provide interactivity. For example, a first action may be taken if a purchaser or other user is detected within a vicinity of the first module 104, while a second action may be taken if the purchaser or other user is operating one or more buttons or other input devices 124.

The responses provided by the first module 104 may be presented via an output device 128. Typically, the output device 128 will be configured to generate an output that can be perceived by a purchaser or user. For example, an output device 128 may be a speaker, light, vibration generator, display screen, motor, the like, or various combinations there of. The output device 128 may also or alternatively be a signal generator for a remote device. For example, the output device 128 may be a video output to a remote monitor. In this manner, the output device 128 provides a signal or other output that can be presented via the remote or external device. Having perceived an output from the first module, the purchaser may conduct his or her future actions accordingly. There may be multiple output devices 128, such as to provide various forms of output to a purchaser.

It is contemplated that the first module 104 may have a power supply 132 in one or more embodiments. In general, the power supply 132 will accept a power input and generate a power output that is usable by the components of the first module 104. It is noted that a power supply 132 may not be provided if such components can use the power input directly.

One benefit of a power supply 132 is that it may, but need not, be used to supply power to other modules. For example, in the embodiment of FIG. 1, the power supply 132 is coupled to one or more power outputs 136. In this manner, input power may be received from a single source (e.g., a wall outlet, battery, generator) and be distributed to one or more modules via one or more power outputs 136. The processor 108 may optionally be in communication with one or more power outputs 136 such as to control the amount of power provided by the power outputs and/or to activate or deactivate individual power outputs. It is noted that a power output 136 may change its output to power particular types of modules.

Since the first module 104 may include one or more power outputs 136, it can be seen that the first module can be used as a central or main module in one or more embodiments. In other words, the first module 104 may provide resources (such as power and/or data) to the other modules while the interactive product locator is in operation. It is contemplated that the modules may be configured to function independently in some embodiments however. For example, each module may have its own power supply or power source.

As stated above, the interactive product locator may comprise multiple modules. FIG. 2 illustrates an exemplary second module 204. In one embodiment, one or more second modules 204 may be used with a single first module. In another embodiment, one or more second modules 204 may be used with one or more first modules. In yet another embodiment, only second modules 204 may be used to form the interactive product locator. Further details regarding the user of various modules to together will be provided below.

As can be seen, a second module 204 may comprise one or more processors 208 and one or more integrated or separate memory devices 212. A processor or controller 208 and memory device 212 of a second module 204 may be like that of a first module and thus the above description is applicable to a controller 208 and memory device 212 of the second module 204. For instance, like a first module, the controller 208 here may execute one or more internal or externally accessible instructions to provide the functionality of the second modules 204 in cooperation with one or more other components of the second module. It is noted that a second module 204 may, but need not, include one or more storage devices, such as those described above such as for additional storage capacity.

A second module 204 may also comprise one or more communications devices 220. A communication device 220 may be configured to provide one or two way communication with a first module and/or other devices. The communication device 220 of a second module 204 may communicate wirelessly or via one or more cables using various standard or proprietary communication protocols. In addition, to be able to communicate with a first module, a communication device 220 may be configured to communicate compressed and/or encrypted data.

It is noted that a variety of data may be communicated via a communication device 220. For example, instructions for controlling the operation of a second module may be received via a communication device 220 from a remote server, a first module, or other device. In addition, various information used or provided by the interactive product locator may be communicated to a second module 204, such as for storage and/or presentation. For example, product information, advertisements, promotional information, etc. . . . may be received by a second module 204 via a communication device 220. It is noted that this capability may reduce or eliminate the need for a storage device/storage capacity at the second module 204.

In one or more embodiments, a communication device 220 may be used to receive an activation or triggering command or data. Once this command is received, a second module 204 may be activated. For example, the second module 204 may produce an output as a result of receiving an activation command of some type.

As can be seen, the second module 204 may include one or more presentation devices 224. In general, a presentation device 224 produces output for a purchaser or other user to perceive. For example, a presentation device 224 may be a speaker, light, display screen, vibration generator, motor, the like, or various combinations thereof. As a result of receiving an activation command, the second module 204 may activate or change the state of one or more of its presentation devices 224. For example, a light or sound may be presented as a result of an activation command. It is noted that activation commands may define a particular action to be taken by the second module 204. For example, a first activation command may result in a particular video being presented on the second module, while a second activation command may result in another video presentation, or a different type of presentation entirely. To illustrate, the presentation may be a sound or light for the second activation command. It is noted that the activation commands and their resulting actions at one or more second modules 204 may be defined by a merchant or other person/entity providing the interactive product locator. The first module is also configurable in this manner.

A second module 204 may also include one or more input devices 228. For example, one or more buttons, switches or the like may be input devices 228. In addition, an input device 228 may be various sensors or detectors. For example, an input device 228 may be a proximity detector, motion detector, camera, or microphone. A second module 204 may receive various input from purchasers and other users via these input devices 228. For example, a second module 204 may detect the presence of a purchaser and activate a particular output as a result. As another example, the second module 204 may detect when a product is picked up by a purchaser and activate a particular output. It is contemplated that input received at a second module 204 may be shared with other modules, including first modules, such as via a communication device 220.

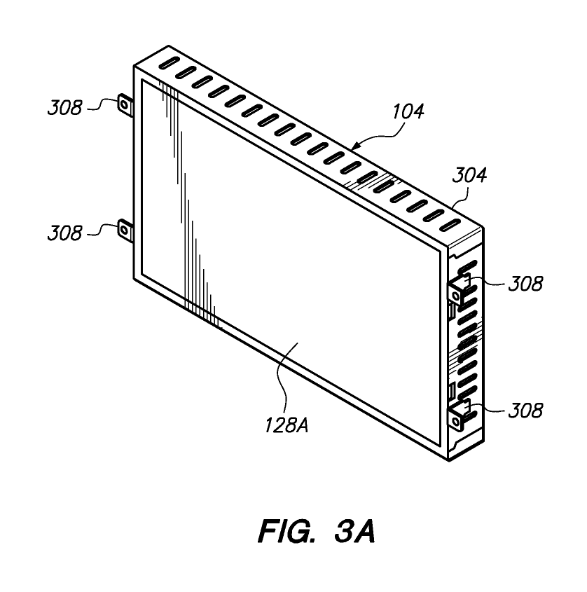

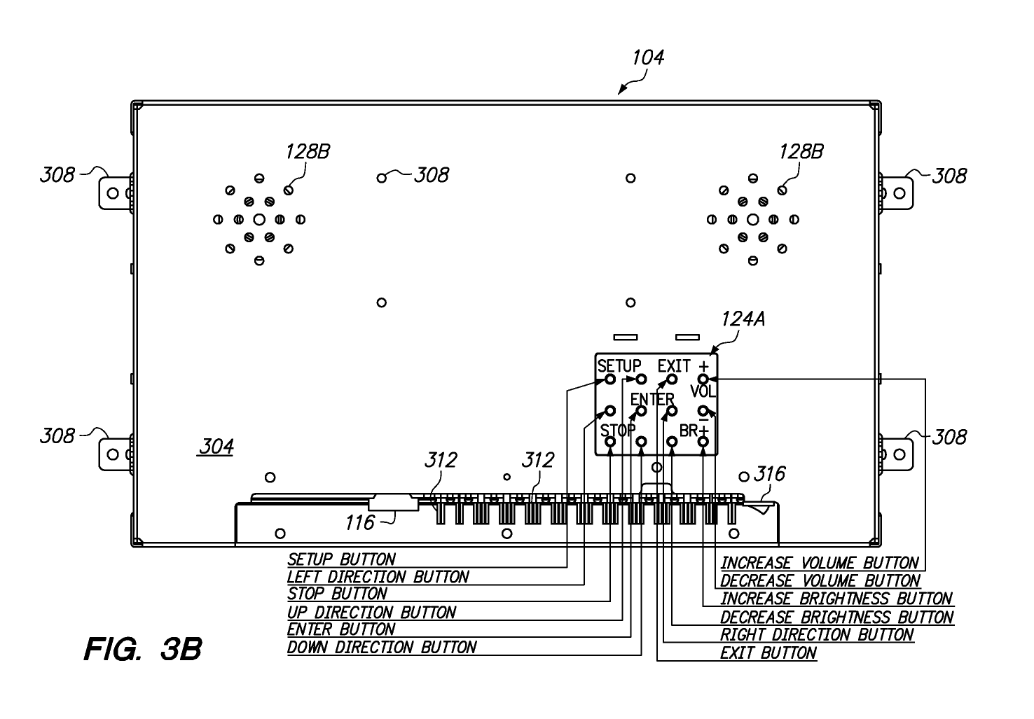

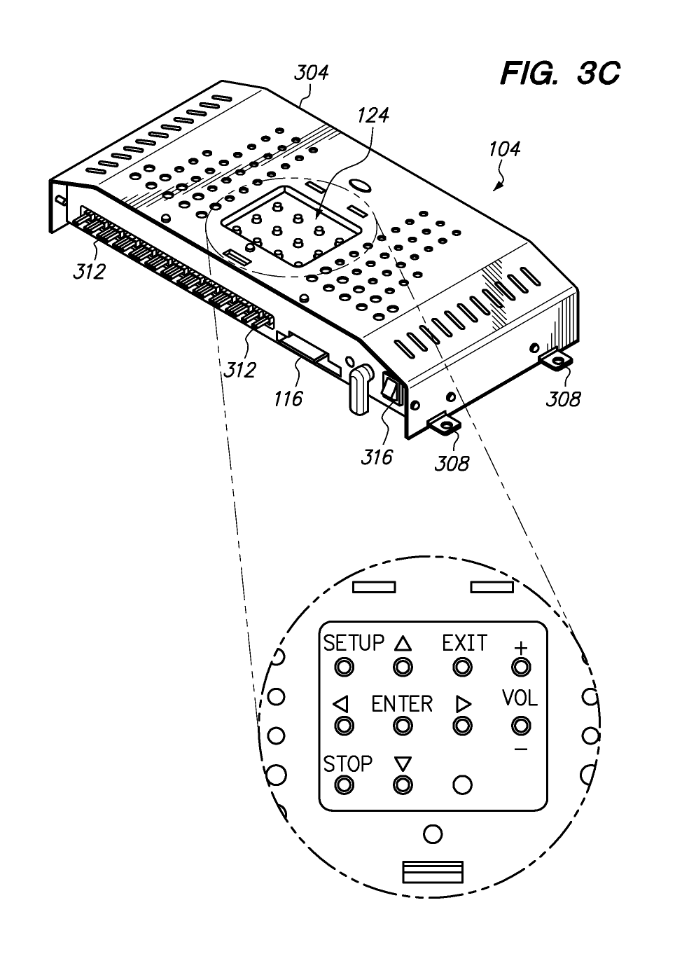

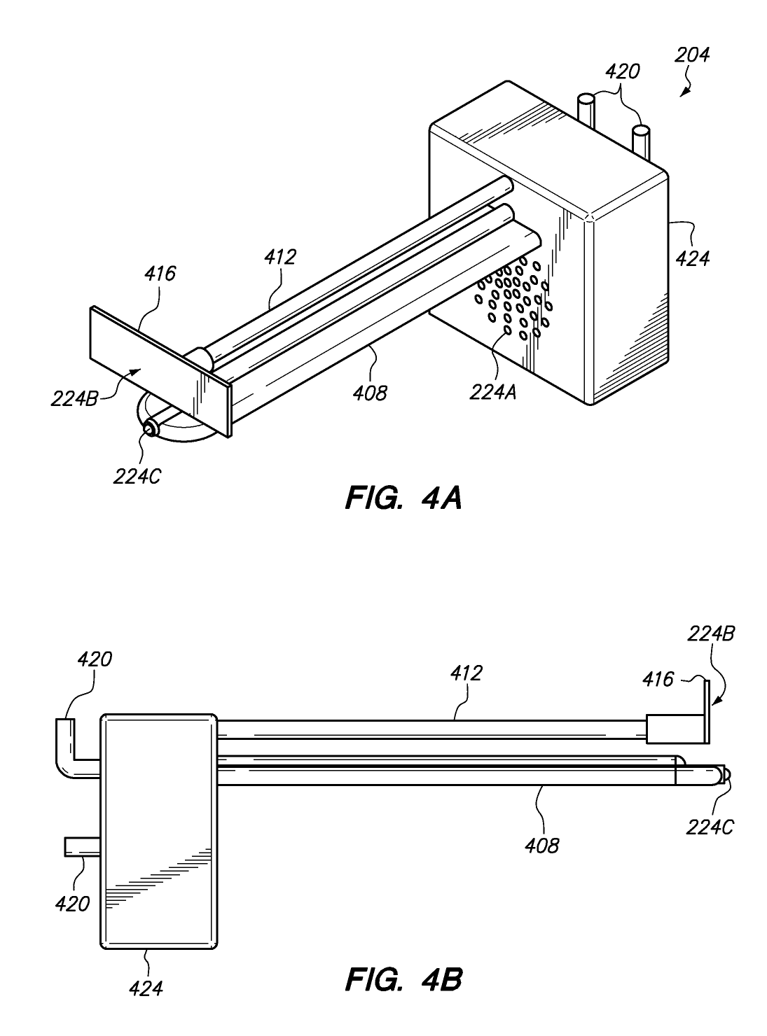

Some exemplary configurations of first modules and second modules will now be described with regard to FIGS. 3A-3C and FIGS. 4A-4B. FIG. 3A is a perspective view of an exemplary first module 104. As can be seen, this embodiment includes an output device in the form of a display screen 128A. Such screen may be an LCD, OLED, or similar type of screen. It is noted that the screen may also function as an input device if it were configured as a touch screen. As can be seen, the first module 104 may be within an enclosure 304. In addition, one or more mounts 308 or the like may be provided to attach the first module 104 to various surfaces or structures.

FIG. 3B provides a rear view of an exemplary first module 104. It is noted that the location of various components of the first module 104 is illustrative and, as such, these components may be located at various locations of the enclosure 304. As can be seen, a first module 104 may have an output device in the form of one or more speakers 128B. In addition, a first module may have input devices in the form of buttons 124A. As shown, the buttons 124A have been configured to configure the first module 104, such as by allowing navigation of configuration or other menus and by accepting various configuration settings or information. It can also be seen, that the first module 104 may have a removable storage device 116, such as the SD card shown in FIG. 3B.

Also, the first module 104 may comprise one or more terminals 312 to connect one or more components to the first module externally. For example, one or more input devices or output devices may be connected via a terminal 312. A terminal may comprise one or more electrical leads and/or an optical connection in some embodiments. A terminal 312 may also be configured to provide power such as to power another module or device, or a component of the first module. The first module 104 may also have an on/off switch 316.

As can be seen, the components that need not be readily accessible to a purchaser may be positioned at the back or rear of the first module 104, such as to prevent such components from be accessed or tampered with.

FIG. 3C illustrates another embodiment of the first module 104 without a display screen. As can be seen, the first module 104 may be within an enclosure 304 without a display screen. Such an embodiment may still include one or more input devices 124, output devices 128, storage devices 116, and/or terminals 312 such as to described above. One of the terminals 312 may provide a connector through which a signal may be provided to an external display screen or monitor.

FIGS. 4A-4B respectively illustrate a perspective and side view of an exemplary second module 204. In one or more embodiments, the second module 204 may comprise an enclosure 424 configured to hold one or more components of the second module 204. For example, a processor, memory device, and/or communication device may be within the enclosure 424. Other components may also be held by the enclosure 424. For example, an output device in the form of a speaker 224A may be held by the enclosure 424, such as shown. It is contemplated that the enclosure 424 may secure or hold components internally or externally.

The enclosure 424 may include a mounting assembly 420 in one or more embodiments. For example, the mounting assembly shown in FIGS. 4A-4B is configured to mount the enclosure 424 to a peg board. As can be seen, the enclosure 424 has a mounting assembly including hooked members and a straight member to engage and mount to a peg board. It is contemplated that the mounting assembly 420 may have a variety of configurations to allow the second module 204 to attach or be secured to various surfaces or structures.

For example, the mounting assembly may be one or more suction cups for mounting to glass or a similar surface. The mounting assembly could also include one or more threaded openings or fasteners such as to allow the second module 204 to be secured by screws or the like. The mounting assembly may comprise one or more magnets, hook and loop fasteners, clips, clamps, hooks, or other fasteners as well. It is contemplated that the mounting assembly may emulate various sign or display mounts so as to permit the mounting assembly to attach to traditional retail fixtures. In some embodiments, a mounting assembly per se may not be provided. In such embodiments, the enclosure 424 may be configured to secure or mount to a surface or structure. For example, the enclosure may have an “L” or other angled shape for placement on a shelf.

In some embodiments, the second module 204 may also provide support to one or more products. For example, as shown, the second module 204 has a product support arm 408 extending from its enclosure 424. The product support arm 408 may hold one or more products to present the products for purchase. By holding the products adjacent the second module 204, a purchaser can quickly associate any output or presentation from the second module with the products. In this manner, the second module 204 can be associated with a product and vice versa. This association between a second module 204 and a product may be made by physical contact or by proximity. For example, a product hanging from a product display arm 408 may be associated with that particular second module 204. Likewise, the closest second module 204 may be deemed associated with a product. Typically, the products and their associated second modules 204 will have a close physical proximity so that purchasers can readily perceive this association.

Additional structures may extend from the enclosure 424 as well, such as to hold various components of the second module 204 at a position remote from the enclosure. For example, as shown, a second arm 412 has been provided. The second arm 412 provides a mount 416 to hold product information, such as in the form of a static printout (or the like) or an electronic display 224B. For example, pricing information may be attached to the mount 416 for presentation to purchasers. In an electronic embodiment, various information may be displayed on the electronic display 224B. Such information may be dynamically changed. In some embodiments, a full color display may be provided to present information. Alternatively, the output device on the second arm 412 may be a segmented LCD display, a light, speaker, or other output device. It is noted that one or more output devices may be mounted to the product display arm 408 if desired. For example, as shown, a light 224C has been mounted to the end of the product display arm 408.

It is contemplated that an input device configured to detect the removal of a product may be mounted to the product display arm 408 in some embodiments. In this manner, the second module 204 may detect when a product is removed and potentially activate a particular output for presentation to a purchaser as a result. Various other input devices may be mounted to the product display arm 408, enclosure 424 or other structure of the second module 204 as well.

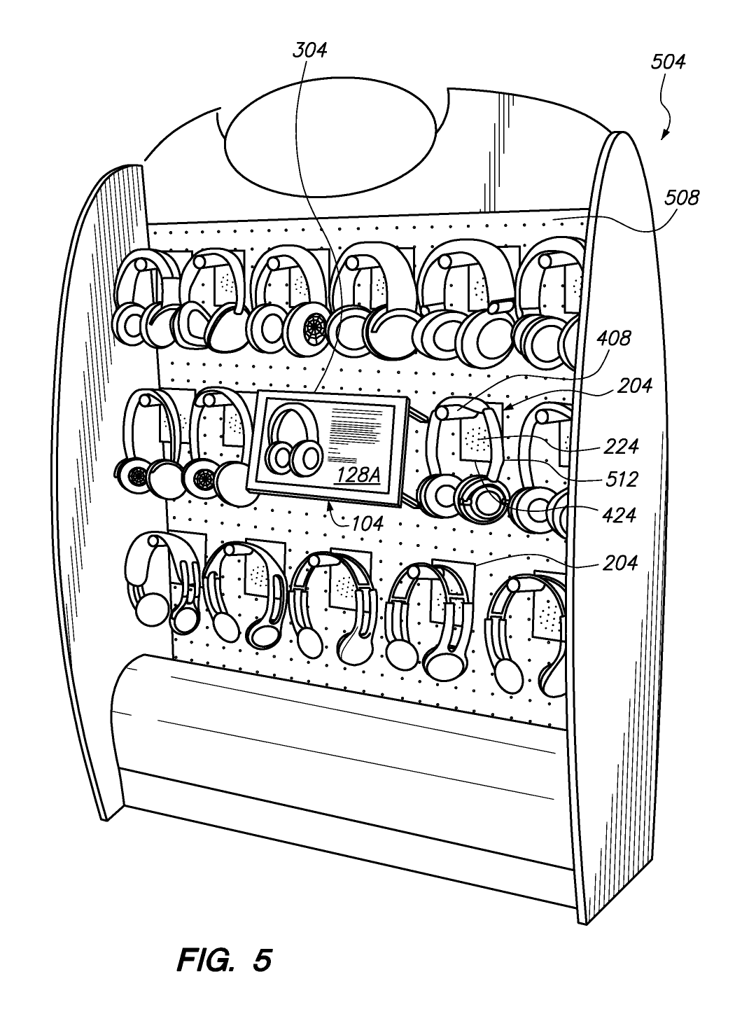

FIG. 5 illustrates an exemplary retail fixture 504 having the interactive product locator installed thereon. As can be seen, the retail fixture 504 is configured to present products 512, namely headphones, for purchase. It is noted that a wide variety of products 512 and even services may be presented for purchase in this manner. In the case of services, a brochure may be provided for each service offered.

The first module 104 and second module 204 may be mounted to a retail fixture 512 as FIG. 5 illustrates. It is contemplated that the first module 104 may be at a remote location in some situations. For example, the first module 104 may be at a store entrance (or other location) while the retail fixture 512 and one or more second modules 204 are at another remote location. In some situations, the second modules 204 and/or retail fixture may not be visible from where the first module 104 is located.

Where the first module 104 and one or more second modules 204 are within the same retail fixture 504, power may be shared between the modules. For example, one module may accept power from an outlet or other power source, such as a battery, and share or provide it to the other modules. In FIG. 5 for example, the first module 104 may accept AC or battery power from a power source and distribute it to the second modules 204 that are also present within the retail fixture 504.

In one or more embodiments, power may be provided via cables or wirelessly. It is contemplated that the retail fixture 504 itself may have one or more conductors/cables to facilitate the distribution of power to/from the modules. For example, a panel or backer 508 of a retail fixture 504 may have one or more electrical conduits embedded or installed thereon. The backer 508 or other portion of the retail fixture 504 could also or alternatively have power outlets which provide power to the modules as they are installed on the retail fixture.

In some embodiments, each module may be self powered. For example, each module may have a power source, such as a battery, or may individually connect to a power supply, such as disclosed above. In such case, power distribution cabling or conductors may not be provided.

In general, the first module 104 may provide product information and/or directions indicating where a particular product may be found. The second modules 204 may identify to a purchaser the specific product he or she was looking at on the to first module 104. Referring to FIG. 5 for example, the product being displayed on the display screen 128A of the first module 104 may be identified by a light 224C, speaker 224A, or other output device of a second module 204 holding that product.

As can be seen, the interactive product locator increases purchaser convenience at a retail fixture 504. This is because detailed or other product information can be displayed in close proximity to the products themselves. In addition, the interactive product locator can identify specific products from a collection of similar products. For example, in FIG. 5, an individual pair of headphones could be highlighted from the collection of headphones in the retail display 504. This allows the purchaser to quickly hone in on a particular product.

This is advantageous in that it prevents a purchaser's attention from being drawn to a potentially competing product. For example, once a purchaser has decided to purchase a product presented via the first module 104, he or she may simply pickup that product as identified by a second module 204. To illustrate, the purchaser may view product information about Products A, B, and C. Once the purchaser has decided to purchase Product C, such decision may be inputted into the first module 104, which in turn may communicate with the particular second module(s) 204 associated with Product C. These second module(s) 204 may them illuminate, generate a sound, or provide other output to allow the purchaser to quickly identify the product's physical location and then pickup the product for purchase. The purchaser is then not distracted by other products since the purchaser does not have to scan the entire retail fixture 504 to locate the product he or she desires. It is contemplated that only some of the products in a retail fixture 504 may utilize the interactive product locator and benefit from its identification features. It is noted that the second modules 204 may be configured to automatically identify their products as the purchaser browses product information for various products on the first module 104.

The interactive product locator is also highly advantageous in that it provides product education to purchasers. This may occur in an entertaining and/or engaging manner through the interactive product locator's modules. For example, a purchaser may input his or her criteria for a particular type of product and receive a display of matching products at one of the modules (typically a first module 104). The matching products may all be identified by the second module(s) 204 associated with these products. The purchaser can then peruse the products via the first module 104 or physically to find the product he or she wishes to purchase.

As another example, once a purchaser has found a product to purchase, a second module 204 associated with that product may recommend additional products such as by outputting audio, video, or other information. This may occur automatically or may occur upon the second module 204 detecting the presence or proximity of a purchaser, or upon the removal of a product associated with the second module.

As yet another example, the purchaser may initiate or trigger a sequence of events undertaken by one or more modules of the interactive product locator. For example, the second modules 204 for a product and its accessories may output various information in a predefined or random sequence. In this manner, a purchaser may easily identify a product as well as its accessories, and potentially be enticed to to purchase one or more of the accessories.

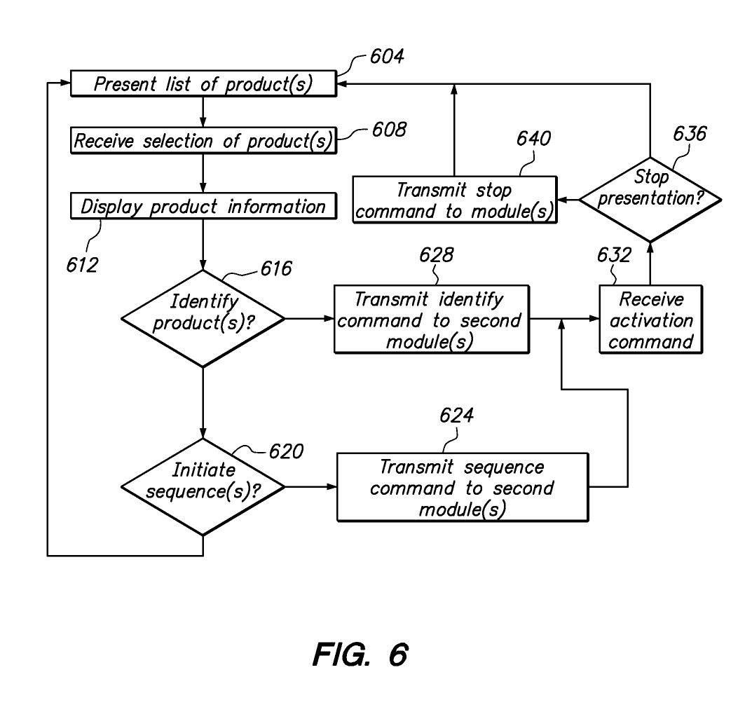

FIG. 6 is a flow diagram illustrating operation of an exemplary interactive product locator. It is noted that various of the steps shown and described herein may be performed by a first module, while other steps may be performed by a second module. To illustrate, in the exemplary illustration of FIG. 6, the steps within the broken lines may be performed by or at one module, while steps outside the broken lines may be performed by or at another module. As described herein, the steps within the broken lines are performed by or at a first module for example.

As discussed above, the first module may be configured with a display screen (or other output device) or be connected to a display screen (or other output device) to present information about one or more products. This is beneficial in that it allows the first module to function as a salesperson by informing purchasers about available products. In addition, the first module may allow purchasers to search for particular products, by name, specifications, or other characteristics. Purchasers may utilize one or more input devices to scroll through and find various products, and otherwise interact with the output they are presented with. The resulting list of one or more products retrieved from a storage or memory device via the first module may be presented via an output device of the first module at a step 604.

At a step 608, a purchaser selection of a product may be received, such as via an input device of the first module. This selection may trigger a predefined action at the first module (and other modules). For example, at a step 612, additional information about the selected product may be presented as a result of the purchaser's selection of the product. In one embodiment, product specifications, promotions, to discounts or other offers, rebates, comparisons, and other product information may be presented upon selection of the product. The product information may be a multimedia presentation or may be solely visual or solely audio. It is contemplated that an animatronic presentation of product information could also be initiated, such as through one or more robotic puppets or the like in communication with the interactive product locator.

Thus it can be seen that the selection of a product may trigger action at the first module. It is contemplated that product selection, such as shown in step 608, may also trigger action at one or more second modules. For example, at a decision step 616, it may be determined if one or more second modules should be activated to identify the selected product to allow the selected product to be easily located.

This may be determined in various ways. For example, the first module may be configured to automatically identify a selected product by transmitting a command indicating the same to the appropriate second module. In another exemplary embodiment, the first module may be configured to present the purchaser with an option to identify the product with a second module. For example, a display or other output may request or prompt purchaser input indicating that the product should be identified. In one or more embodiments, a prompt such as “Locate Product?” or the like may be presented to the purchaser. If the purchaser indicates in the affirmative, then the first module may proceed accordingly.

The identification command may be sent to a second module associated with a selected product at a step 628. It is noted that a database or other data storage format associating particular second modules with particular products may be queried to to determine which of the second modules should be sent the identify command. For example, a table comprising products or product identifiers linked with an identifier (e.g., network address) of an associated second module may be queried to determine which second module should receive the identify command. Such a database may also associated product types, categories, or other groups to a second module. In this manner, an entire group of products can be identified. For example, a purchaser looking for unscented soap among a “sea” of various soaps could have only unscented soap identified by one or more second modules.

Alternatively, the identification command may be sent to all modules. In such case, the identification command may include an identifier of the particular second module that should be activated. Only the second module having a matching identifier would then be activated.

At a step 632, a second module may receive the identification command and activate itself to identify a product to a purchaser. As disclosed above, the second module may activate one or more presentation devices to identify the product. For example, one or more lights, audio or visual, or other presentations may be provided by the second module. In this manner, the purchaser can quickly locate the selected product, and may be drawn in to purchase that product.

At a decision step 636, it may be determined if the presentation at a second module should be stopped. This may occur automatically, such as for example, if the activated presentation is a finite length. Alternatively, an activated presentation may be stopped at other times. For example, the purchaser may stop a presentation by pressing a “Stop” button or the like. Alternatively, input from various sensor input to devices may stop a presentation. For example, detection of a purchaser within a proximity of the second module may cause the presentation to stop. It is noted that another presentation could then begin. To illustrate, a second module may activate a light as a first presentation to identify the product. Once the user is at the product/second module, the first presentation may stop and a second presentation may begin. For example, the second presentation could be an audio or video presentation presented to the user when the user is adjacent the second module and its associated products.

It is contemplated that a presentation may be stopped if no purchasers are in the vicinity, such as determined by one or more sensor input devices of the first module, second module, and/or other modules at a retail fixture. Alternatively or in addition, a presentation may be stopped at a predetermined time has elapsed. This prevents the interactive product locator from becoming a distraction or from utilizing power when it is not needed.

The presentation on a second module may then be stopped at a step 640. In one or more embodiments, the first module may transmit a stop command to a second module to cause the presentation to stop. For example, the purchaser may engage a “Stop” button or the like on the first module causing a stop command to be transmitted to an active second module. Alternatively or in addition, if the purchaser navigates to view another product, previously activated second modules may be sent a stop command. All the second modules may be sent a stop command in some embodiments.

It is contemplated that various modules may send stop commands. For example, one second module may transmit a stop command to another second module. To illustrate, in one embodiment, a second module may send a stop command to other second modules when a purchaser is within its proximity. It is noted that the stop command may be triggered for various predefined input. In this manner, the stop command may be issued from one module to one or more other modules based on the input received at the module's input device(s).

In one or more embodiments, the interactive product locator may be capable of executing presentation sequences in addition or instead of indentifying products. For example, once a product selection is received at step 608, it may be determined at a decision step 620, if a presentation sequence should be activated. If so, an activation command indicating the same may be transmitted to one or more second modules. For example, a sequence command may be sent at a step 624.

In general a presentation sequence involves selective activation of multiple modules in a sequence. The sequence may be random or predefined. As will described in detail further below, a presentation sequence may be used to provide an engaging promotion for one, but typically more than one, product.

At step 632, the activation command (this time a sequence command) is received by a second module. As a result, the second module may activate its presentation. This second module may then trigger the activation of another second module according to a predefined sequence. Alternatively or in addition, individual second modules may be activated in the predefined sequence by a first module. At a decision step 636, it may be determined whether the presentation sequence should be stopped. This determination may be made as disclosed above. If the sequence should to be stopped, this may occur at step 640, also as disclosed above.

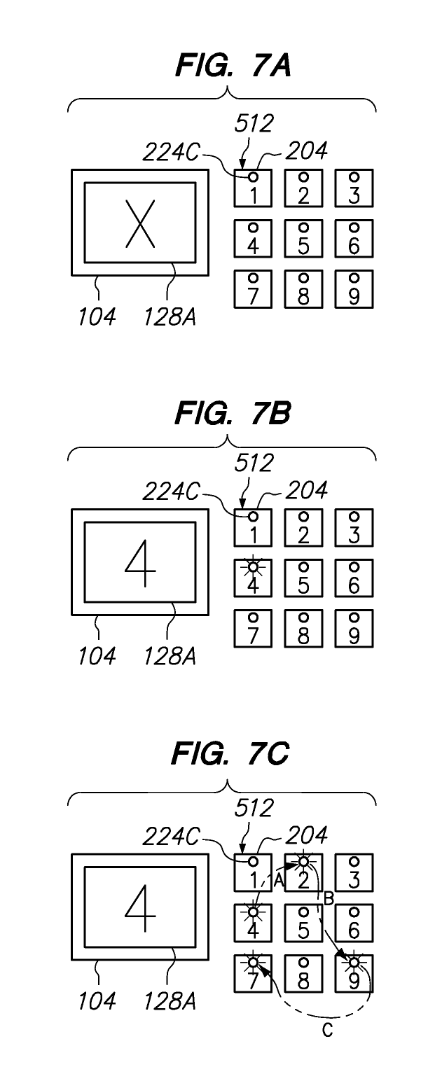

FIGS. 7A-7C illustrate operation of an exemplary interactive product locator in various states. For example, FIG. 7A illustrates an inactive state where some product or other information X is being presented via a display screen 128A of a first module 104. In one or more embodiments, information regarding the products 512 associated with one or more second modules 204 may not be displayed in the inactive state. Instead, advertisements or general information may be presented. A welcome message could also be displayed to encourage purchasers to interact with the interactive product locator. Alternatively, the display screen 128A may be turned off or be blank in the inactive state.

As can be seen, in the inactive state no product is being identified. FIG. 7B illustrates a first activated state. The first activated state may occur when the interactive product locator is called upon or configured to identify a product. To illustrate, it can be seen that information about Product 4 is being displayed on the first module 104. This may arise from Product 4 being selected via one or more input devices of the first module 104, such as described above. As a result, Product 4 is also being identified by a light 224C of its associated second module 204, while other products are not identified. This makes it easy for a purchaser to locate Product 4.

FIG. 7C illustrates multiple stages of a second activated state that may arise when the interactive product locator is called upon or configured to present a presentation sequence. As can be seen, Product 4 is also being viewed on the first module 104, presumably as a result of being selected. In this example however, a presentation sequence is activated whereby second modules 204 for Product 4, to Product 2, Product 9, and finally Product 7 are activated in sequence. This is shown by the activation of their lights 224C. It will be understood that various presentations may be provided. For example, activation of a second module 204 may cause one or more audio or video presentations, such as disclosed above. In some embodiments, the presentation sequence may be rapid. In fact, multiple modules may be active at the same time. In other embodiments, the presentation sequence may be such that only one second module 204 is active at a time.

It is contemplated that a presentation sequence may activate one or more second modules 204 repeatedly. In this manner, a conversation may occur between second modules 204. For example, lines of dialog, sounds, lights, or video may occur in a sequence that simulates a back and forth conversation between two or more second modules 204.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. An interactive product locator comprising:
a first module comprising:
one or more input devices configured to receive a product selection from a user, the product selection identifying one or more selected products from a plurality of products; and
one or more communication devices configured to transmit one or more activation commands;
a plurality of second modules associated with one or more or the plurality of products, the one or more second modules comprising:
one or more communication devices configured to receive the one or more activation commands; and
one or more presentation devices configured to activate upon receipt of the one or more activation commands;
wherein the first module is configured to send the one or more activation commands upon receipt of the product selection, and at least one of the second modules associated with the one or more selected products is activated as a result.

2. The interactive product locator of claim 1, wherein the plurality of second modules comprise one or more supports configured to hold one or more of the plurality of products.

3. The interactive product locator of claim 1, wherein the plurality of second modules comprise one or more mounts configured to secure the plurality of second modules to a retail fixture.

4. The interactive product locator of claim 1, wherein the one or more presentation devices comprise an output device selected from the group consisting of one or more speakers, one or more lights, and one or more display screens.

5. The interactive product locator of claim 1, wherein the first module further to comprises a display screen configured to display product information for the plurality of products.

6. The interactive product locator of claim 1 further comprising a storage device configured to store one or more product identifiers in association with one or more second module identifiers to allow the plurality of second modules to be associated with one or more of the plurality of products.

7. The interactive product locator of claim 1, wherein the first module comprises one or more power outputs electrically coupled to the plurality of second modules to provide power to the plurality of second modules.

8. An interactive product locator for a retail fixture comprising:
one or more first modules at the retail fixture, the one or more first modules configured to receive an input from a user, the input identifying one or more first products;
a plurality of second modules at the retail fixture, the plurality of second modules configured to generate an output perceivable by the user to identify a product to a user, the plurality of second modules associated with the one or more first products and one or more second products, wherein the one or more first products are different from the one or more second products; and
one or more communication devices configured to communicate one or more activation commands between the one or more first modules and the plurality of second modules, wherein the plurality of second modules associated with the one or more first products generate the output upon receiving the one or more activation commands while the plurality of second modules associated with the one or more second products do not generate the output.

9. The interactive product locator of claim 8, wherein the plurality of second modules comprise one or more support arms for holding the one or more first products and the one or more second products.

10. The interactive product locator of claim 8, wherein the plurality of second modules associated with the one or more first products generate the output according to a predefined sequence.

11. The interactive product locator of claim 8, wherein the one or more communication devices are configured to communicate one or more stop commands, wherein the plurality of second modules associated with the one or more first products stop generating the output upon receiving the one or more activation commands.

12. The interactive product locator of claim 8, wherein the one or more first modules comprise a display screen for displaying the one or more first products.

13. The interactive product locator of claim 8, wherein one or more of the to plurality of second modules comprise a display screen for generating the output perceivable by the user to identify the product to the user.

14. The interactive product locator of claim 8, wherein the retail fixture is a peg board.

15. The interactive product locator of claim 8, wherein the retail fixture is a shelving unit.

16. A method of locating products with an interactive product locator comprising:
receiving at a first module a product selection identifying one or more selected products;
retrieving from a storage device one or more second module identifiers associated with the one or more selected products;
transmitting one or more activation commands to one or more second modules identified by the one or more second module identifiers; and
activating a presentation device at the one or more second modules identified by the one or more second module identifiers to identify the one or more selected products to a user.

17. The method of claim 16 further comprising deactivating the presentation device at the one or more second modules identified by the one or more second module identifiers after a predetermined period of time.

18. The method of claim 16 further comprising deactivating the presentation device at the one or more second modules identified by the one or more second module identifiers upon receipt of an input at the first module.

19. The method of claim 16, wherein activating the presentation device at the one or more second modules identified by the one or more second module identifiers occurs by activating the presentation device of each of the one or more second modules according to a predefined sequence.

20. The method of claim 16 further comprising receiving the one or more selected products on a support of the one or more second modules identified by the one or more second module identifiers.
